(19) United States
(12) Patent Application Publication
(10) Pub. No.: US 2025/0316731 A1
(43) Pub. Date: Oct. 9, 2025

(54) METHOD FOR CALIBRATING A DEVICE FOR REGULATING THE RETURN FLOW IN A FUEL CELL SYSTEM

(71) Applicant: Robert Bosch GmbH, Stuttgart (DE)

(72) Inventor: Helerson Kemmer, Vaihingen (DE)

(21) Appl. No.: 18/715,174

(22) PCT Filed: Nov. 21, 2022
(86) PCT No.: PCT/EP2022/082631

§ 371 Date: May 31, 2024

(30) Foreign Application Priority Data
Dec. 2, 2021 (DE) 10 2021 213 656.7

(51) Int. Cl. H01M 8/04746; H01M 8/04089; H01M 8/04111; H01M 8/04223; H01M 8/0444

(52) U.S. Cl. CPC H01M 8/04753; H01M 8/04097; H01M 8/04111; H01M 8/04231; H01M 8/04447

(57) ABSTRACT

A method for calibrating a device for regulating the return flow (70) in a fuel cell system (1), the fuel cell system (1) having a fuel cell stack (101), an air path (10), an exhaust gas line (12) and a fuel line (20) with a recirculation circuit (50).

The following method steps are carried out:
a. setting a stationary load point of the fuel cell system (1);
b. fixing the current drawn from the fuel cell stack (101);
c. actuating a device for regulating the return flow (70) such that exhaust gas from the exhaust gas line (12) flows via a return flow line (66) into the air path (10);
d. increasing the mass flow of exhaust gas flowing through the return flow line (66) by actuating the device for regulating the return flow (70) until a hydrogen concentration can be measured at a hydrogen sensor (64);
e. defining the maximum permitted mass flow of exhaust gas through the return flow line (66) for the previously selected stationary load point.

### BACKGROUND

The present invention describes a method for calibrating a device for regulating the return flow in a fuel cell system.

Hydrogen-based fuel cell systems are considered to be the mobility concept of the future, because they only emit water as exhaust gas and enable fast fueling times. In this context, cell systems need air and hydrogen for the chemical reaction within the cells. In order to supply the required amount of energy, the fuel cells arranged within a fuel cell system are interconnected to form so-called fuel cell stacks. The waste heat of the cells is in this case dissipated by means of a cooling loop and released to the environment. The hydrogen required for operating fuel cell systems is generally provided to the systems from high pressure tanks.

Exhaust gas is known to initiate from the exhaust gas path of a fuel cell into the air path because it provides benefits in certain operating conditions, such as for freeze starts or shutdown procedures. A corresponding shutdown procedure is known from the application with file number 102018213695.5. A recirculation of exhaust gas into the air path is also known from application Ser. No. 10/202,1205335.1.

### SUMMARY

The object of the invention is a method having the features of the independent method claim. Further features and details of the invention arise from the respective dependent claims, the description, and the drawings.

The method according to the invention is used to provide a method for calibrating a device for regulating the return flow in a fuel cell system. The method according to the invention offers the advantage that the maximum possible mass flow or the maximum possible recirculation rate is determined up to which recirculation of the exhaust gas is feasible without damage to the fuel cell stack.

A mixture of exhaust gas from the exhaust gas path into the air of the air path may be useful under different boundary conditions. A typical operating condition in which exhaust gas recirculation into the air line may be useful is a partial load operation of the fuel cell in which a minimum speed of the compressor may not be undercut. To reduce the amount of oxygen in the air supplied to the fuel cell stack via the air line, exhaust gas may be added to the oxygen-containing air. A further positive effect is the humidification of the air by the water in the exhaust gas, which prevents the fuel cell stack from drying out.

The method according to the invention makes it possible to define the maximum permitted amount of exhaust gas that can be fed to the air without preventing normal fuel cell operation due to an insufficient oxygen content along the entire cell, and thus a proton pump operation takes place at least at certain points.

Once too little oxygen is fed to the fuel cell stack at an operating point, a proton pump is used because the existing oxygen is already consumed by the front cells and the rear cells in the fuel cell stack are no longer supplied with oxygen. As oxygen is not available, the individual hydrogen molecules combine with each other to form H2 as part of the proton pumping process. This hydrogen is then transported with the exhaust gas into the exhaust gas path and can be detected at the hydrogen sensor.

The method according to the invention for calibrating a device for regulating a return flow in a fuel cell system, wherein the fuel cell system has a fuel cell stack, an air path, an exhaust gas line and a fuel line with a recirculation circuit, comprising the following method steps:
a. setting a stationary load point of the fuel cell system;
b. fixing the current drawn from the fuel cell stack;
c. actuating a device for regulating the return flow such that exhaust gas from the exhaust gas line flows via a return line into the air path;
d. increasing the mass flow of exhaust gas flowing through the return flow line by actuating the device for regulating the return flow until a hydrogen concentration can be measured at a hydrogen sensor;
e. defining the maximum permitted mass flow of exhaust gas through the return flow line for the previously selected stationary load point.

Advantageous embodiments and developments of the method according to the invention are specified in the dependent claims.

It is advantageous if the actuation of the device for regulating the return flow associated with the maximum permitted mass flow is stored, as this value is easier to reproduce.

It is advantageous if no purge and/or draining process is carried out during the performance of the method steps, as they can falsify a measurement due to the hydrogen content in the recirculation circuit.

If the purge and/or draining process has not been stopped, it should be checked whether a purge and/or drain process has occurred when the hydrogen sensor has measured a hydrogen concentration in order to discard these measurement results if necessary. In this case, carrying out the method steps d.) to e.) enables the calibration of the existing operating point.

The method according to the invention can be used in particular in fuel cell-powered motor vehicles. However, it is also conceivable to use the method in other fuel cell-powered transportation means, such as cranes, ships, rail vehicles, flying objects, or even in stationary fuel cell-powered objects.

### BRIEF DESCRIPTION OF THE DRAWINGS

Shown are:

FIG. 1 a schematic representation of a fuel cell system according to the invention according to a first exemplary embodiment;

FIG. 2 a schematic representation of a fuel cell system according to the invention according to a second exemplary embodiment;

FIG. 3 a flowchart of the individual steps of a method according to the invention according to a first exemplary embodiment; and

FIG. 4 a flowchart of the individual steps of a method according to the invention according to a second exemplary embodiment.

### DETAILED DESCRIPTION

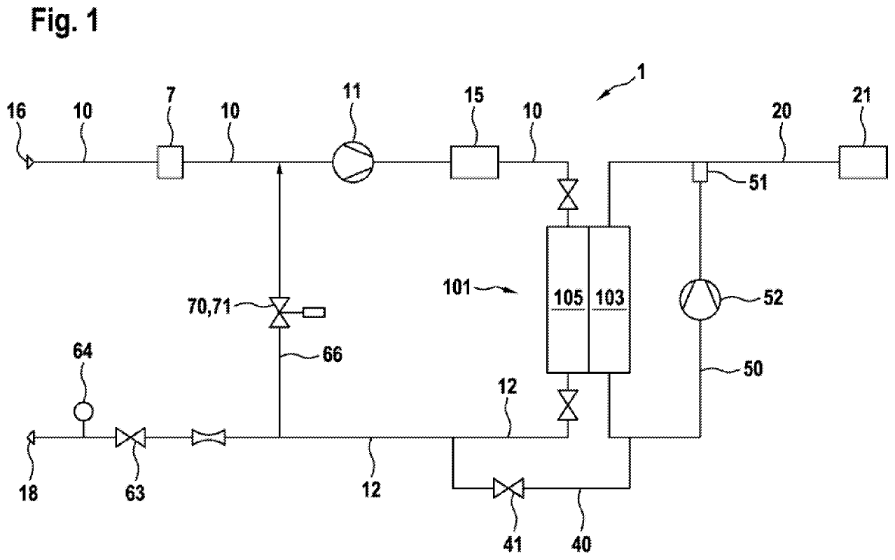

FIG. 1 shows a schematic topology of a fuel cell system 1 according to a first exemplary embodiment of the invention, having at least one fuel cell stack 101. The at least one fuel cell system 1 comprises an air path 10, an exhaust gas line 12, and a fuel line 20. The at least one fuel cell stack 101 can be used for mobile applications with a high power specification, for example in trucks, or for stationary applications, for example in generators.

The air path 10 serves as an air supply line for supplying air from the environment to a cathode 105 of the fuel cell stack 101 via an inlet 16. Components needed for the operation of the fuel cell stack 101 are arranged in the air path 10. An air compressor 11 and/or compressor 11, which compresses and/or draws in the air in accordance with the respective operating conditions of the fuel cell stack 101, is arranged in the air path 10. A heat exchanger 15 which heats or cools the air in the air path 10 can be located downstream of the air compressor 11 and/or the compressor 11.

Further components, e.g., a filter 7 and/or a humidifier and/or valves, can be provided in the air path 10. Air containing oxygen is made available to the fuel cell stack 101 via the air path 10.

The fuel cell system 1 also comprises an exhaust gas line 12, in which water and other components of the air from the air path 10 are transported into the environment via an outflow 18 after passing through the fuel cell stack 101. The exhaust gas of the exhaust gas line 12 can also contain hydrogen (H2), because portions of the hydrogen can diffuse through the membrane of the fuel cell stack 101 or are conveyed via a purge line 40 into the exhaust gas line 12. For this reason, a hydrogen sensor 64, which can measure the concentration of hydrogen, is located upstream of outlet 18.

A pressure control valve 63 is arranged in the exhaust gas line 12, which can throttle the flow in the exhaust gas line 12 so that different pressures can be adjusted upstream of the pressure control valve 63.

The fuel cell system 1 can moreover comprise a cooling loop designed to cool the fuel cell stack 101. The cooling loop is not shown in FIG. 1, because it is not part of the invention.

A high pressure tank 21 and a shut-off valve 22 are located in the inflow of fuel line 20. Additional components can be arranged in the fuel line 20 so as to supply fuel to an anode side 103 of the fuel cell stack 101 as needed.

In order to always adequately supply the fuel cell stack 101 with fuel, there is a need for an over-stoichiometric metering of fuel via the fuel line 20. The excess fuel, and also certain amounts of water and nitrogen that diffuse through the cell membranes to the anode side, are recirculated in a recirculation circuit 50 and mixed with the metered fuel from the fuel line 20.

Various components, such as a jet pump 51 operated with the metered fuel or a blower 52, can be installed in order to drive the flow in the recirculation circuit 50. A combination of jet pump 51 and blower 52 are possible as well.

In order to remove unnecessary constituents, such as nitrogen or water, from the recirculation circuit 50, the recirculation circuit 50 is connected to the exhaust gas line 12 via a purge line 40 in which a purge valve 41 is arranged. During a purge and/or draining process, the purge valve 41 is opened so that a gas mixture of the unnecessary constituents and hydrogen may flow from the recirculation line 50 into the exhaust gas line 12.

The exhaust gas line 12 is connected to the air path 10 via a return flow line 66. A device for regulating the return flow 70 is arranged in the return flow line 66. Depending on the actuation of the device for regulating the return flow 70, exhaust gas from the exhaust gas line 12 may flow into air path 10 via the return flow line 66.

According to the first exemplary embodiment in FIG. 1, the device for regulating the return flow 70 is a controllable valve 71. When the controllable valve 71 is closed, exhaust gas from the exhaust gas line 12 may not flow into the air path 10 via the return flow line 66. When the controllable valve 71 is open, exhaust gas flows from the exhaust gas line 12 into the air path 10 via the return flow line 66. By changing the opening cross-section of the controllable valve 71, the mass flow of exhaust gas may be increased or decreased via the return flow line 66.

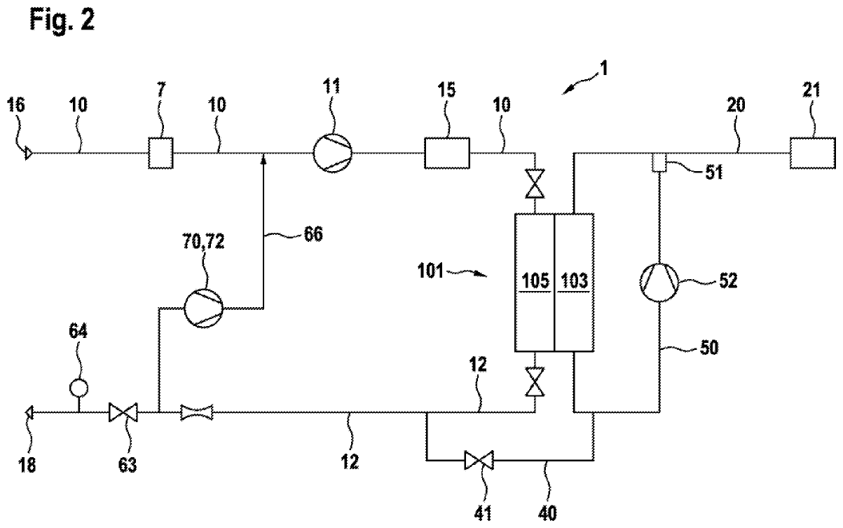

FIG. 2 shows a schematic topology of a fuel cell system 1 according to a second exemplary embodiment of the invention. In the second embodiment, the device for regulating the return flow 70 is realized as a blower 72. When the blower 72 is deactivated, exhaust gas from exhaust gas line 12 does not flow into the air path 10 via the return flow line 66. When the blower is activated, exhaust gas from exhaust gas line 12 flows into the air path 10 via the return flow line 66. By changing the speed of the blower 72, the mass flow of exhaust gas may be increased or decreased into the air path 10 via the return flow line 66.

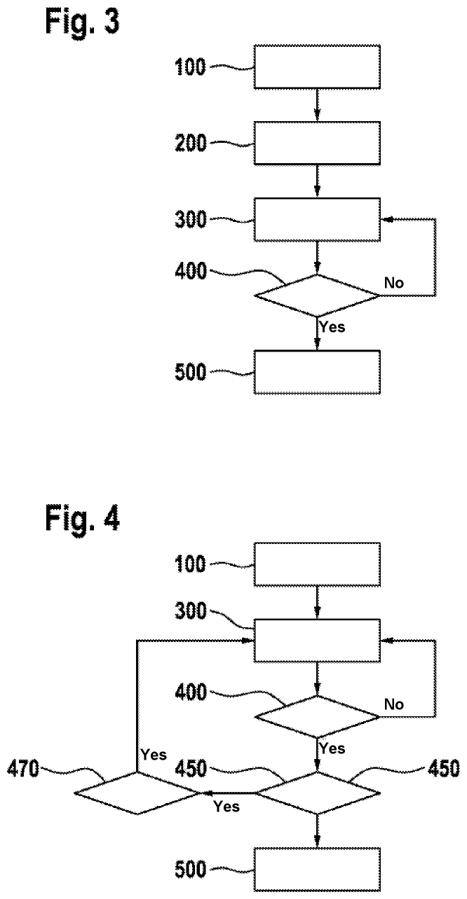

FIG. 3 shows a flowchart of the single steps of a first exemplary embodiment of a method according to the invention for calibrating a device for regulating the return flow 70 in a fuel cell system 1.

In a method step 100, a stationary load point of the fuel cell system is set and the current drawn from the fuel cell 101 is kept constant.

In a method step 200, the purge and/or draining process is prevented, so that the purge valve 41 cannot be opened during the method according to the invention,.

In a method step 300, the device for regulating the return flow 70 is actuated, such that the exhaust gas from the exhaust gas line 12 can flow into the air path 10 via a return flow line 66 or the mass flow is increased from the exhaust gas line 12 via a return flow line 66 into the air path 10.

In a method step 400, it is checked whether a hydrogen concentration can be measured at the hydrogen sensor 64. If this is not the case, the method step 300 is repeated and the mass flow flowing from the exhaust line 12 via a return flow line 66 into the air path 10 is increased by actuating the device for regulating the return flow 70.

If a hydrogen concentration can be measured at the hydrogen sensor 64 in the method step 400, method step 500 is carried out and the current mass flow is considered the maximum permitted mass flow of exhaust gas through the return flow line 66 for the previously selected stationary load point. Alternatively, a mass flow that is below the current mass flow may be selected as the maximum permitted mass flow in order to prevent proton pumping taking place in the rear region of the cells of the fuel cell stack 101.

FIG. 4 shows a flowchart of the single steps according to a second exemplary embodiment of a method according to the invention for calibrating a device for regulating the return flow 70 in a fuel cell system 1.

In a method step 100, a stationary load point of the fuel cell system is set and the current drawn from the fuel cell 101 is kept constant. The procedure of keeping the current drawn from the fuel cell 101 constant can also be described under the following expression: fixing the current drawn from the fuel cell stack 101. From the method step 100, method step 300 is directly carried out.

In a method step 300, the device for regulating the return flow 70 is actuated, such that the exhaust gas from the exhaust gas line 12 can flow into the air path 10 via a return flow line 66 or the mass flow is increased from the exhaust gas line 12 into the air path 10 via a return flow line 66.

In a method step 400, it is checked whether a hydrogen concentration can be measured at the hydrogen sensor 64. If this is not the case, the method step 300 is repeated and the mass flow flowing from the exhaust gas line 12 via a return flow line 66 into the air path 10 is increased by actuating the device for regulating the return flow 70.

If a hydrogen concentration can be measured at the hydrogen sensor 64 in method step 400, then method step 450 is carried out.

In method step 450, it is checked whether a purge and/or draining process has occurred. If so, the measurement results are discarded and a method step 470 is carried out, otherwise method step 500 is carried out.

In a method step 470, after completion of the purge and/or draining process, the mass flow through the return flow line 66 is reduced and method step 300 is carried out again.

In the method step 500, the current mass flow is selected as the maximum permitted mass flow of exhaust gas through the return flow line 66 for the previously selected stationary load point. Alternatively, a mass flow that is below the current mass flow may be selected as the maximum permitted mass flow in order to prevent pumping taking place in the rear region of the cells of the fuel cell stack 101.

1. A method for calibrating a device for regulating a return flow (70) in a fuel cell system (1), the fuel cell system (1) having a fuel cell stack (101), an air path (10), an exhaust gas line (12) and a fuel line (20) with a recirculation circuit (50), wherein the following method steps are carried out:
a. setting a stationary load point of the fuel cell system (1);
b. fixing the current drawn from the fuel cell stack (101);
c. actuating a device for regulating the return flow (70) such that exhaust gas from the exhaust gas line (12) flows via a return flow line (66) into the air path (10);
d. increasing the mass flow of exhaust gas flowing through the return flow line (66) by actuating the device for regulating the return flow (70) until a hydrogen concentration can be measured at a hydrogen sensor (64);
e. defining the maximum permitted mass flow of exhaust gas through the return flow line (66) for the previously selected stationary load point.

2. The method according to claim 1, wherein the actuation of the device for regulating the return flow (70) associated with the maximum permitted mass flow is stored in the method step e.

3. The method according to claim 1, wherein no purge and/or draining process is carried out during the performance of the method steps.

4. The method according to claim 1, wherein, in method step d.), if a hydrogen concentration is measured at the hydrogen sensor (64), it is checked whether a purge and/or draining process has occurred, and in this case the measurement results are discarded so that step e.) is not performed.

5. The method according to claim 4, wherein, following method step d.), after completion of the purging and/or draining process, the mass flow through the return flow line (66) is reduced and the method steps d.) to e.) are carried out again.

6. The method according to claim 1, wherein the device for regulating the return flow (70) is a controllable valve (71), wherein the mass flow of the exhaust gas via the return flow line (66) is increased by an increase in the opening cross-section of the controllable valve (71).

7. The method according to claim 1, wherein the device for regulating the return flow (70) is a blower (71), wherein the mass flow of the exhaust gas via the return flow line (66) is increased by a speed increase of the blower (65).

8. The method according to claim 1, wherein the stationary load point of the fuel cell system (1) is achieved by not changing the air compressor (11) and further actuators arranged in the fuel cell system (1).
